(19) United States
(12) Patent Application Publication
(10) Pub. No.: US 2004/0118185 A1
(43) Pub. Date: Jun. 24, 2004

(54) Method for detecting leaks in structures

(76) Inventor: John Duerr, Massapequa Park, NY (US)

Correspondence Address: Robert E. Cannuscio, Drinker Biddle & Reath LLP, One Logan Square, 18th & Cherry Streets, Philadelphia, PA, 19103-6996, US

(21) Appl. No.: 10/732,552

(22) Filed: Dec. 9, 2003

Related U.S. Application Data
(60) Provisional application No. 60/435,560, filed on Dec. 20, 2002.

(51) Int. Cl. G01M 3/20

(52) U.S. Cl. 73/40.7; 73/104; 250/372

(57) ABSTRACT

The present invention is directed to a system for detecting leaks in weather-proof enclosures, such as buildings or automobile bodies, including small leaks that are active only when the automobile is driven at high speed in rain or snow. An applicator includes a chamber in between a pressurized water inlet and a discharge nozzle. A user points the nozzle at a suspected leak area in the enclosure and turns on the water supply to create a water stream through the applicator. As the stream passes through the chamber, fluorescent dye is drawn or displaced from a dye reservoir and mixed with the water. A mixture of fluorescent dye and water is thereby sprayed onto the suspected leak area through the nozzle. The interior of the enclosure is inspected with an inspection lamp to determine if the suspected leak area includes a leak.

### RELATED APPLICATION

This application is related to and claims priority from U.S. Provisional Application Serial No. 60/435,560, filed Dec. 20, 2002, which is incorporated herein by reference in its entirety.

### FIELD OF THE INVENTION

The present invention relates to the field of detecting leaks in weather-proof enclosures, such as buildings, slate roofs, mobile homes or any other body intended to keep out environmental elements. The method described herein is particularly well suited for detecting small leaks in the body of a vehicle, such as an automobile or truck, that may be active only when the vehicle is driven at high speed in rain or snow.

### BACKGROUND OF THE INVENTION

The very nature of an automobile body requires that it be built from several parts, many of which must move relative to one another. For example, doors must open to allow the operator and passengers to enter and exit the automobile. Further, almost all automobiles are equipped with windows that can be lowered and raised at the election of an occupant and a trunk hatch. Unfortunately, each of these moving parts provides and opportunity for a leak to develop and allow rain or other environmental elements to enter the vehicle.

However, moving parts are not the only place where leaks can develop in an automobile body. The junction between any two pieces of the autobody can prove to be troublesome. For example, leaks have been known to develop between the frame of the auto and the windshield, in the doors of the automobile or in the floor of the vehicle.

In order to prevent a leak from developing in the autobody, vehicle manufactures have provided various forms of seals between parts of the autobody. Most automobile operators are familiar with some common seals, such as weather stripping provided around the doors of the vehicle. In addition, rubber, foam or other sealing materials are often provided around windows to keep out environmental elements. However, seals can never be completely effective since defects can develop as the result of normal wear or due to an automobile collision. In addition, initial installation of the seals can be done imperfectly. Furthermore, manufacturing tolerances or inconsistencies can lead to leaks. Thus, autobodies are prone to develop leaks despite the best intentions of manufacturers.

Several attempts to detect leaks in autobodies have been made. Some systems, such as the one described in U.S. Pat. No. 3,580,054 to Schlumbaum, utilize a suction device that can be placed against an opening in an automobile body to draw air from the interior of the vehicle. The presence or absence of a leak in the autobody is determined by measuring the pressure within the suction conduit. Although such systems can determine whether a leak is present, they are not efficient for identifying the source of the leak or whether there is more than one leakage location.

A computer controlled leak detection system is described in U.S. Pat. No. 6,354,139 to Menovick et al. The system includes an enclosure into which an automobile can be driven. Three nozzle arrays are mounted on movable structures that can be juxtaposed against the sides and top of a vehicle. A fixed nozzle array is also provided for spraying the bottom of the vehicle. The nozzles are supplied with pressurized water from a single pump through a series of distribution mains and manifolds.

One disadvantage of the Menovick system is its size and lack of portability. Most service stations or repair shops have inadequate space to install such an enclosure for detecting leaks. In addition, the plurality of nozzles for spraying water on the test vehicle are supplied from a single pump. Thus, the pressure output from the pump is dispersed through several lengths of supply pipes, multiple manifolds and hoses. One potential problem with such an arrangement is that the system may not output adequate pressure from a single nozzle to force water through a small leak in the autobody, which may only be active when the vehicle is driven at high speed in the rain or snow.

It has also been known to use fluorescent dye and an inspection lamp to locate leaks. In general, dye is pre-mixed with water and then poured onto the vehicle body. However, this method is also not entirely effective because the mixture must be manually applied, which can not create the pressure required to force the mixture through a small leak. Moreover, preparing the mixture is time consuming, messy and also wasteful if all of the mixture is not used.

Thus, there exists a need for a method of detecting small leaks in an autobody or other enclosure and a highly portable, clean and effective device for doing so.

### SUMMARY OF THE INVENTION

The present invention is a method for detecting leaks in an enclosure, such as a building or vehicle. The method preferably involves using a dye applicator in the form of a hand held sprayer with a water inlet for receiving pressurized water, a nozzle for discharging fluid and a chamber therebetween. A fluorescent dye reservoir is connected with the nozzle through a dye tube for infusing fluorescent dye into a mixing zone. In one embodiment, a conduit is provided in the wall of the chamber to allow fluid from the chamber to enter the dye reservoir to mix with a dye concentrate. The inflowing fluid forces the dye mixture to flow through the dye tube back into the main water flow. Alternatively, a venturi tube can be incorporated in the chamber to draw dye from the reservoir. In addition, an airline may be used to provide an air supply to the chamber from a remote air supply.

In operation, a user points the nozzle of the dye applicator at a suspected leak area in an automobile body. Water is introduced under pressure through the inlet into the chamber. As water passes through the chamber to the nozzle, fluorescent dye is displaced or drawn from the dye reservoir at a predetermined rate of flow into a mixing zone. In addition, air from the remote air supply may be drawn or forced under pressure into the mixing chamber, which increases turbulence within the chamber and mixing zone, and increases the velocity of the fluid discharged from the nozzle. Thus, a mixture of water and dye is sprayed onto the suspected leak area at high velocity, simulating the effect of driving the automobile at high speed during a rain or snow storm. By inspecting the interior of the vehicle with an inspection lamp, the user determines whether the suspected leak area contains a leak, even a small leak that is only active when the vehicle is driven at high speed in the rain or snow.

The foregoing and other features of the invention and advantages of the present invention will become more apparent in light of the following detailed description of the preferred embodiments, as illustrated in the accompanying figures. As will be realized, the invention is capable of modifications in various respects, all without departing from the invention. Accordingly, the drawings and the description are to be regarded as illustrative.

### BRIEF DESCRIPTION OF THE DRAWINGS

For the purpose of illustrating the invention, there are shown in the drawings schematic representations and photographs of apparatus that can be used with the present invention; it being understood, that this invention is not limited to the precise arrangements shown.

FIG. 1 is a side view of a preferred dye applicator used with the present invention.

FIG. 2 is a cross-sectional view of the dye applicator of FIG. 1 illustrating one embodiment for providing mixing of a dye and a fluid stream.

FIG. 3 is a cross-sectional view of the dye applicator of FIG. 1 illustrating a second embodiment for providing mixing of a dye and a fluid stream.

FIG. 4 is a schematic block diagram generally depicting the present invention.

FIG. 5 illustrates the use of the present invention for detecting a leak on a structure.

FIG. 6A illustrates an embodiment of the invention wherein the dye reservoir is provided as a removably attachable sealed container.

FIG. 6B illustrates the embodiment of FIG. 6A with the dye reservoir attached to the housing.

### DETAILED DESCRIPTION OF THE INVENTION

In the drawings, there are schematically shown dye applicators for testing suspected leak areas of an automobile body and photographs of a preferred applicator. The apparatus is first shown schematically to demonstrate the elements of the apparatus and to provide an understanding of its method of operation. In practice, the elements shown and described can be incorporated into many shapes and configurations convenient for a user to handle.

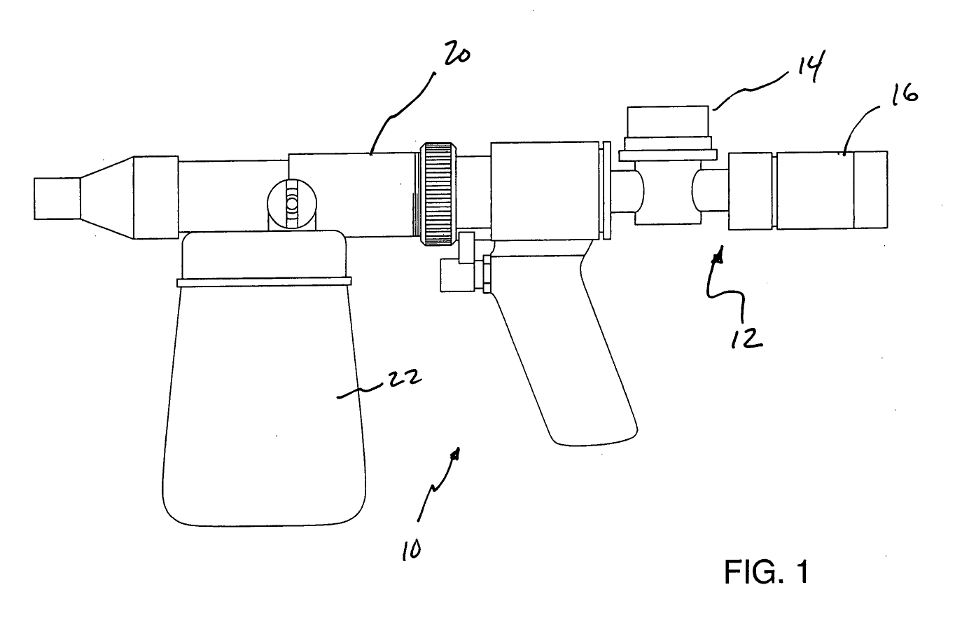

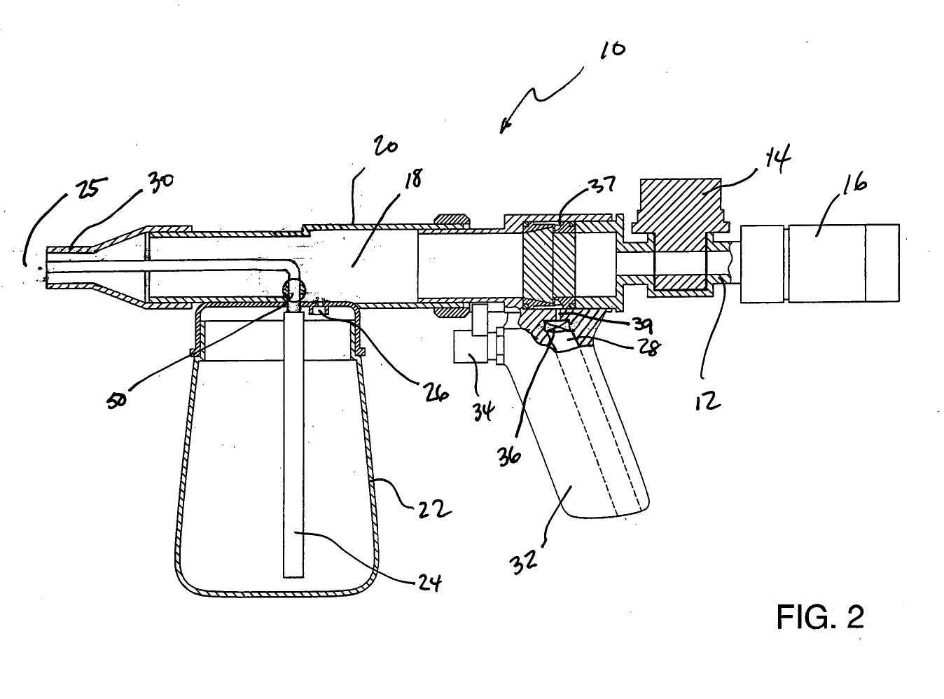

FIGS. 1 and 2 show an applicator 10 that includes a water inlet 12 with a user operable valve 14. The valve 14 may be of any known valve design and can be actuated via a user-actuated element, such as a trigger or rotating actuator. A coupling 16, such as a threaded collar, connects the inlet 12 to a hose or other source of pressurized water (not shown). The inlet 12 is in fluid communication with a first end of a chamber 18 located within a housing 20.

A dye reservoir 22 is preferably connected to the housing 20. As shown in FIG. 2, the reservoir 22 can be a replaceable plastic bottle attached to the housing with a bayonet connection so as to facilitate easy attachment and removal. The reservoir 22 is designed to receive a dye, such as a fluorescent dye, for mixing with a pressurized water. The dye is preferably a water soluble dye. Suitable dyes are commercially available from Spectronics Corporation of Westbury, N.Y., such as those sold under part numbers TP-3900 and TP-3920. The dye can be incorporated into the reservoir as a powder, liquid, slurry, pill or wafer. A fluid input aperture 26 connects the chamber 18 with the reservoir 22 to allow fluid to enter the reservoir 22. Water entering the reservoir 22 displaces dye through a dye supply tube 24 into a mixing zone 25 outside of the chamber 18. The size of the dye supply tube 24 and input aperture 26 are proportioned to infuse dye into the mixing zone 25 at a predetermined rate. The flow rate will vary depending on the volume and rate of the water flow through the chamber 18.

Also preferably connected to the chamber 18 is an airline 28 which supplies air to the chamber 18 from a remote source (not shown). An inlet 39 of the airline 28 is located in the wall of the housing 20 so as to provide air into the chamber 18. A manifold 37 can be positioned adjacent the inlet 39 within the housing 20 to distribute the incoming air around the periphery of the chamber 18, thus providing substantially even distribution of the air into the water stream. In the illustrated embodiment, the inlet 39 is positioned upstream of the input aperture 26. It is also contemplated that the airline inlet 39 can be located anywhere within the chamber 18. However, in situations where the airline is pressurized, it is preferred that it be positioned on the upstream side of the input aperture 26 to assist with displacement of dye from the reservoir 22. The bottom of the airline can be provided with a threaded fitting (not shown) for connecting with an air hose leading to a compressor in a conventional manner.

A nozzle 30 is provided on a second end of the chamber 18 for discharging pressurized fluid into the mixing zone 25. A handle 32 may be provided for the convenience of a user, thereby assisting in directional control of the discharged spray. Where the air supply is pressurized, a trigger 34 or other control device may be incorporated into the device to actuate a valve 36 for controlling the flow of air through the airline 28.

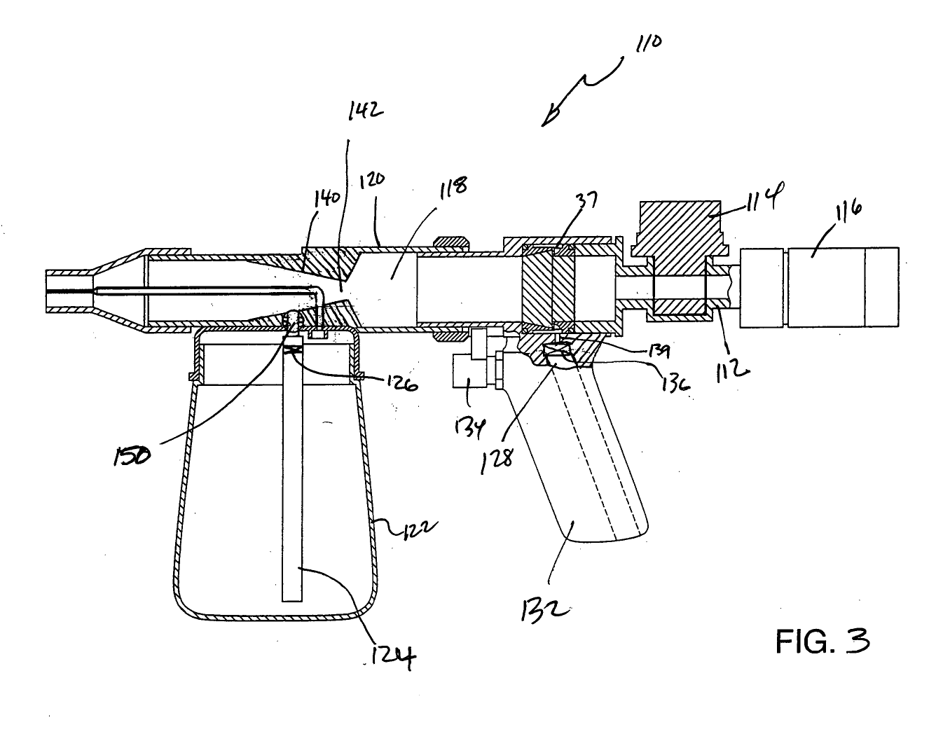

FIG. 3 shows a second type of applicator 110 that includes a water inlet 112 with a user operable valve 114. The valve 114 may be of any known valve design and can be actuated via a user-ac tuated element, such as a trigger or rotating actuator. A water supply connector 116, connects the inlet 112 to a source of pressurized water (not shown). The inlet 112 is in fluid communication with a first end of a mixing chamber 118 located within a housing 120.

A dye reservoir 122 is preferably connected to a venturi tube 142, which is defined by venturi members 140 within the mixing chamber 118, through a dye inlet tube 124. The reservoir 122 is provided with dye, such as fluorescent dye, for mixing with the pressurized water. A one-way check valve 126 may be incorporated into the dye inlet tube 124. In response to the water passing through the mixing chamber 118, the one-way check valve 126 allows dye to pass through the dye inlet tube 124 into the mixing chamber 118, but prevents back-flow of fluid into the dye reservoir 122. The size of the dye inlet tube 124 and check valve 126 are proportioned to allow dye to enter the mixing chamber 118 at a predetermined rate. The flow rate would vary depending on the volume and rate of the water flow through the mixing chamber 118.

Also preferably connected to the mixing chamber 118 is an airline 128 which supplies air to the mixing chamber from a remote source (not shown). An inlet 139 of the airline 128 is located in the mixing chamber 118 so as to provide additional mixing of the dye with the water. In the illustrated embodiment, the inlet 139 is positioned upstream of the dye tube 124. However, it is also contemplated that the airline inlet 139 can be located anywhere within the mixing chamber 118, including downstream of the dye inlet tube 124.

A nozzle 130 is provided on a second end of the mixing chamber 118 for discharging mixed pressurized fluid. Any conventional nozzle can be used on the spray applicator and may be designed so as to permit variation in the output stream profile by twisting or sliding of the nozzle relative to the housing.

It is also contemplated that a valve may be incorporated into the device so as to control flow into and/or out of the dye reservoir. As shown in FIGS. 2 and 3, a dye flow valve 50, 150 may be attached to an end of the dye inlet line 124. In the illustrated embodiment, a rotary valve is used to control dye flow. When the valve is closed, only water passes (and optionally air) through the chamber and into the mixing zone, thus allowing the device to dispense high pressure water. By controlling the different valves (water valve, air valve and dye valve), the flow rate and mixture characteristics can be accurately controlled. For example, the dye valve controls the amount of dye that flows into the mixing chamber and, thus, controls the intensity of the dye mixture. The water valve controls the rate of water permitted into the mixing chamber, thus controlling the output. The air valve controls the amount of mixing and assists in controlling the flow of the output mixture. It is also contemplated that the air valve can be used to produce foaming of the mixture if desired.

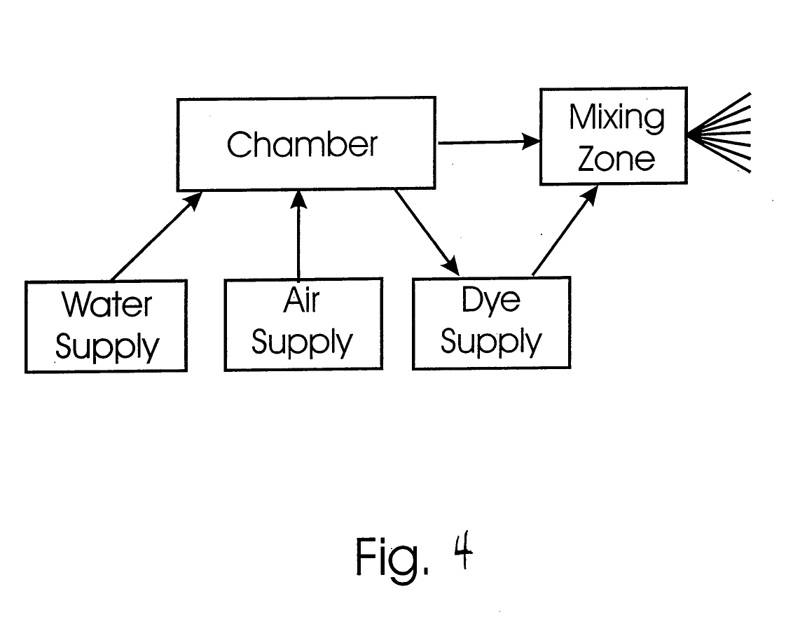

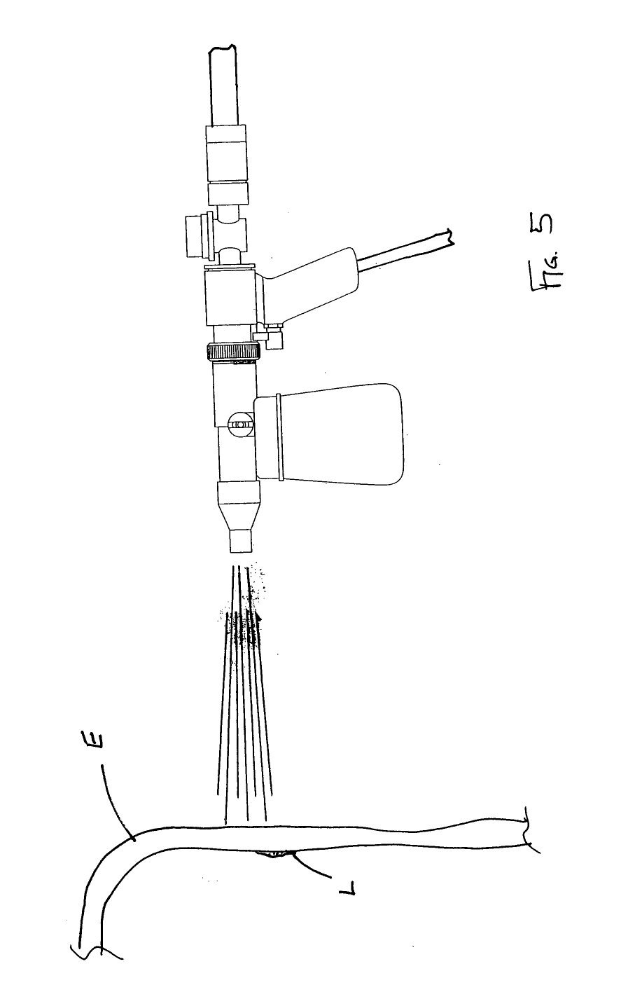

The use of the applicator of FIGS. 1 and 2 will now be discussed with reference to FIGS. 4 and 5. The user points the discharge nozzle 30 of the applicator 10 at a suspected leak area of an enclosure E, such as an automobile body, and actuates the valve 14 to introduce pressurized water into the chamber 18. A water stream is produced through the chamber 18 from the first end adjacent inlet 12 to the second end adjacent nozzle 30, where a high-pressure spray is discharged into mixing zone 25. As the water stream flows through the chamber 18, pressure is established within the chamber 18, forcing some fluid into the dye reservoir 22 through the fluid input aperture 26. As fluid enters the reservoir 22, fluorescent dye is displaced through dye tube 24 into the mixing zone 25, where it mixes with the high-velocity fluid being discharged from the nozzle 30. As the mixture hits the structure, it is forced through any leakage locations and, thus, shows up on the opposite side of the structure.

In addition, air can be drawn or forced into the mixing chamber from the remote source through the airline 28. The introduction of air creates additional turbulence within the chamber 18 and increases the velocity of the fluid discharged through the nozzle 30. Pressurized air is preferred for increasing discharge velocity. However, ambient air is also beneficial. Using ambient air from a remote source ensures that the airline does not get clogged by the high velocity fluid discharged from the nozzle or any debris dislodged from the enclosure being tested by the force of the spray.

The applicator 100 shown in FIG. 2 is used in a similar fashion. When the applicator 110 is used, dye becomes mixed with the water within mixing chamber 118 before being discharged through nozzle 130. As the water (and optionally air) passes through the venturi, it creates a suction in the dye inlet tube 124, drawing dye from the reservoir into the mixing chamber 118.

The present invention is particularly useful for testing for leaks on vehicles, tractor trailers, shipping containers or other items that are subject to being impacted by pressurized fluid. For example, when used with a vehicle, the high velocity discharge of water and dye mixture simulates high speed travel of the automobile under storm conditions. Once the suspected leak area of the structure has been thoroughly sprayed with the mixture, the interior of the structure is inspected using an inspection lamp. Suitable inspection lamps are commercially available from Spectronics Corporation of Westbury, N.Y. and may be selected based on the dye used. Such lamps include ultraviolet lamps, blue light lamps and dual-spectrum dichroic lamps. If a fluorescent dye is used, any mixture L that has entered (leaked into) the opposite side of the structure will fluoresce under the lamp, thereby indicating that the suspected area of the structure includes a leak. If no fluorescence is observed, then the suspect area is deemed to have no leak and the test can be run on additional areas of the enclosure.

In addition to vehicles, the present invention has applicability for testing for leaks in building, such as sheds, homes, etc, and can be used particularly to detect leaks in roofs, walls, and windows. The invention can be used to simulate rain under various wind gusts and at various angles.

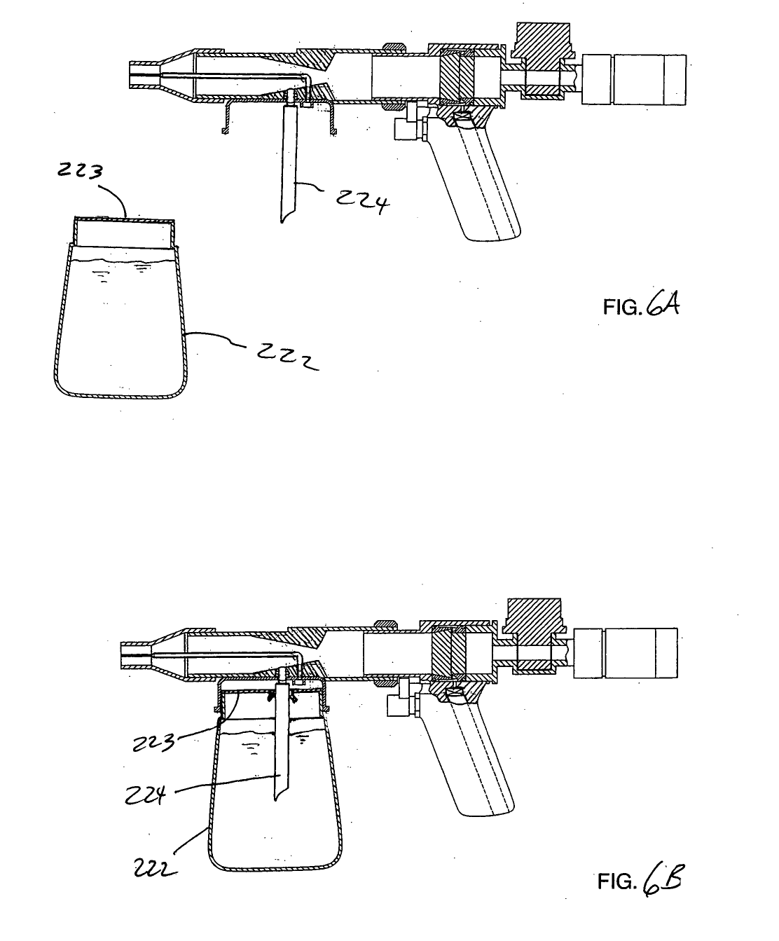

Referring to FIGS. 6A and 6B, an embodiment of the invention is illustrated which includes dye reservoirs 222 that are provided as separate sealed canisters. In this embodiment, the reservoirs 222 come prepackaged with a suitable dye, such as in liquid, powder, pill, slurry, or wafer form. The reservoirs 22 are initially sealed, preferably with a cover 223. When the reservoir 22 is attached to the housing, the cover is pierced by dye inlet tube 224.

As noted above, a variety of modifications to the apparatus and method described will be apparent to those skilled in the art from the disclosure provided herein. Thus, the present invention may be embodied in many specific forms without departing from the spirit or essential attributes thereof and, accordingly, reference should be made to the appended claims, rather than to the foregoing specification, as indicating the scope of the invention.

What is claimed is:

1. A method of testing for a leak in a suspected leak area of a structure, such as a vehicle, the method comprising the steps of:
positioning a spray nozzle of a dye applicator toward a suspected leak area;
channeling pressurized water into a chamber within the applicator to create water flow from an inlet to the spray nozzle;
discharging fluid through the nozzle toward the suspected leak area;
infusing dye from a dye reservoir into a mixing zone at a predetermined flow rate to mix with the water to form a dye mixture; and
inspecting the structure to determine whether any dye mixture has passed from one side of the structure to the other through a leak in the suspected leak area.

2. The method of claim 1 further comprising the step of infusing air into the mixing chamber from a remote source.

3. The method of claim 1 wherein the dye is fluorescent and the inspecting step comprises the step of illuminating an inspection area with an ultraviolet lamp, blue light lamp or dual-spectrum dichroic lamp.

4. The method of claim 1 wherein the structure is a vehicle.

5. The method of claim 1 wherein the structure is a building.

6. The method of claim 1 wherein the dye reservoir is a canister that contains a dye concentrate, and wherein the canister is removably attached to the spray applicator.

7. A method of testing for a leak in an inspection area of a structure, the method comprising the steps of:
providing a structure having an area to be inspected;
providing a spray applicator having a nozzle;
aiming the spray nozzle toward the inspection area;
channeling pressurized water into a chamber within the applicator to create water flow from an inlet to the spray nozzle;
infusing dye from a dye reservoir into a mixing zone at a predetermined flow rate to mix with the water to form a dye mixture;
discharging the dye mixture through the nozzle toward the suspected leak area; and
inspecting the structure to determine whether any dye mixture has passed from one side of the structure to the other through a leak in the inspection area.

8. The method of claim 7 further comprising the step of infusing air into the mixing chamber from a remote source.

9. The method of claim 7 wherein the dye is fluorescent and the inspecting step comprises the step of illuminating an inspection area with an ultraviolet lamp, blue light lamp or dual-spectrum dichroic lamp.

10. The method of claim 7 wherein the structure is a vehicle.

11. The method of claim 7 wherein the structure is a building.

12. The method of claim 7 wherein the step of providing a spray applicator involves providing a dye application kit comprising
a spray applicator including a housing with a mixing chamber located inside the housing, the mixing chamber having a dye inlet, a water inlet, a dye reservoir in communication with the mixing chamber through the dye inlet, the water inlet including a coupling device for connecting a water source to the water inlet, and a spray nozzle in communication with the mixing chamber; and
a dye concentrate.

13. The method of claim 12 wherein the spray applicator further includes an airline in communication with the mixing chamber, the airline adapted to be connected to an air source.

14. The method of claim 7 wherein the step of providing a spray applicator involves providing a dye application kit comprising:
a spray applicator including a housing having a spray nozzle, a dye inlet, a water inlet, a dye reservoir in communication with the dye inlet, and the water inlet including a coupling device for connecting a water source to the water inlet; and
a dye concentrate.

15. The method of claim 7 wherein the dye reservoir is a canister that contains a dye concentrate, and wherein the canister is removably attached to the spray applicator.

16. The method of claim 7 wherein the spray applicator includes a flow meter that controls the dye mixture.

17. The method of claim 16 wherein the flow meter controls the flow of dye into the mixing chamber.

18. The method of claim 16 wherein the flow meter controls the flow of water into the mixing chamber.

19. The method of claim 16 wherein the flow meter controls the flow of air into the mixing chamber.
